(19) United States
(12) Patent Application Publication
(10) Pub. No.: US 2022/0221955 A1
(43) Pub. Date: Jul. 14, 2022

(54) IMPROVED TOUCH SENSING APPARATUS

(71) Applicant: FlatFrog Laboratories AB, Lund (SE)

(72) Inventors: Håkan Bergström, Lund (SE); Tomas SVENSSON, Limhamn (SE); Aleksander KOCOVSKI, Malmö (SE)

(21) Appl. No.: 17/610,407

(22) PCT Filed: May 15, 2020
(86) PCT No.: PCT/SE2020/050504

§ 371 Date: Nov. 10, 2021

(30) Foreign Application Priority Data
May 17, 2019 (SE) 1930159-7

(51) Int. Cl. G06F 3/042

(52) U.S. Cl. CPC G06F 3/0421

(57) ABSTRACT

A touch sensing apparatus is disclosed comprising a panel that defines a touch surface extending in a plane having a normal axis and a back surface opposite the touch surface, a display arranged proximal to the back surface and configured to display an image through a display portion of the touch surface, a plurality of emitters and detectors arranged along a perimeter of the panel and beneath the panel, wherein the emitters are arranged to emit non-visible light and the first and second light directing surfaces are arranged to receive the light and direct the light across the touch surface substantially parallel to the touch surface, wherein the apparatus comprising at least one optical filter arranged outside of the display portion of the touch surface and configured to filter visible light.

### TECHNICAL FIELD

The present invention pertains to touch-sensing apparatus that operate by propagating light above a panel. More specifically, it pertains to optical and mechanical solutions for controlling and tailoring the light paths above the panel via fully or partially randomized refraction, reflection or scattering.

### BACKGROUND ART

In one category of touch-sensitive panels known as ‘above surface optical touch systems’, a set of optical emitters are arranged around the periphery of a touch surface to emit light that is reflected to travel and propagate above the touch surface. A set of light detectors are also arranged around the periphery of the touch surface to receive light from the set of emitters from above the touch surface. I.e. a grid of intersecting light paths are created above the touch surface, also referred to as scanlines. An object that touches the touch surface will attenuate the light on one or more scanlines of the light and cause a change in the light received by one or more of the detectors. The location (coordinates), shape or area of the object may be determined by analyzing the received light at the detectors. Optical and mechanical characteristics of the touch-sensitive apparatus affects the scattering of the light between the emitters/detectors and the touch surface, and the accordingly the detected touch signals. For example, variations in the alignment of the opto-mechanical components affects the detection process which may lead to a sub-optimal touch detection performance. Factors such as signal-to-noise ratio, detection accuracy, resolution, the presence of artefacts etc, in the touch detection process may be affected. While prior art systems aim to improve upon these factors, e.g. the detection accuracy, there is often an associated compromise in terms of having to incorporate more complex and expensive opto-mechanical modifications to the touch system. This typically results in a less compact touch system, and a more complicated manufacturing process, being more expensive. To reduce system cost, it may be desirable to minimize the number of electro-optical components. Some prior art systems rely on precise alignment of the various components of the touch sensing apparatus such as the light emitters- and detectors for improved control of the performance. Such systems may however be cumbersome to reliably implement due to the small tolerances with respect to the alignment of the components. Such precise alignment may be difficult to achieve in mass production.

### SUMMARY

An objective is to at least partly overcome one or more of the above identified limitations of the prior art.

One or more of these objectives, and other objectives that may appear from the description below, are at least partly achieved by means of touch-sensitive apparatuses according to the independent claims, embodiments thereof being defined by the dependent claims.

According to a first aspect, a touch sensing apparatus is provided, comprising a panel that defines a touch surface extending in a plane having a normal axis and a back surface opposite the touch surface, a display arranged proximal to the back surface and configured to display an image through a display portion of the touch surface, a plurality of emitters and detectors arranged along a perimeter of the panel and beneath the panel, wherein the emitters are arranged to emit non-visible light and the first and second light directing surfaces are arranged to receive the light and direct the light across the touch surface substantially parallel to the touch surface, wherein the apparatus comprising at least one optical filter arranged outside of the display portion of the touch surface and configured to filter visible light.

Some examples of the disclosure provide for a touch sensing apparatus that has a better signal-to-noise ratio of the detected light.

Some examples of the disclosure provide for a touch-sensing apparatus with improved resolution and detection accuracy of small objects.

Some examples of the disclosure provide for a touch-sensing apparatus with a more uniform coverage of scanlines across the touch surface.

Some examples of the disclosure provide for a touch-sensing apparatus with less detection artifacts.

Some examples of the disclosure provide for a more compact touch sensing apparatus.

Some examples of the disclosure provide for a touch sensing apparatus that is less costly to manufacture.

Some examples of the disclosure provide for a touch sensing apparatus that is more reliable to use.

Some examples of the disclosure provide for a more robust touch sensing apparatus.

Some examples of the disclosure provide for a touch sensing apparatus which can accommodate larger variations in the alignment of the opto-mechanical components thereof while maintaining high touch detection accuracy and resolution.

Still other objectives, features, aspects and advantages of the present disclosure will appear from the following detailed description, from the attached claims as well as from the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

These and other aspects, features and advantages of which examples of the invention are capable of will be apparent and elucidated from the following description of examples of the present invention, reference being made to the accompanying drawings, in which;

FIG. 1a is a top down view of a touch-sensing apparatus, according to one example of the disclosure;

FIG. 1b is a top down view of a touch-sensing apparatus, according to one example of the disclosure;

FIG. 2 is a schematic illustration, in a cross-sectional side view, of a touch-sensing apparatus, according to one example of the disclosure;

FIG. 3 is a schematic illustration, in a cross-sectional side view, of a touch-sensing apparatus, according to one example of the disclosure;

FIG. 4 is a schematic illustration, in a cross-sectional side view, of a touch-sensing apparatus, according to one example of the disclosure;

FIG. 5 is a schematic illustration, in a cross-sectional side view, of a touch-sensing apparatus, according to one example of the disclosure.

### DETAILED DESCRIPTION OF EXAMPLE EMBODIMENTS

In the following, embodiments of the present invention will be presented for a specific example of a touch-sensitive apparatus. Throughout the description, the same reference numerals are used to identify corresponding elements.

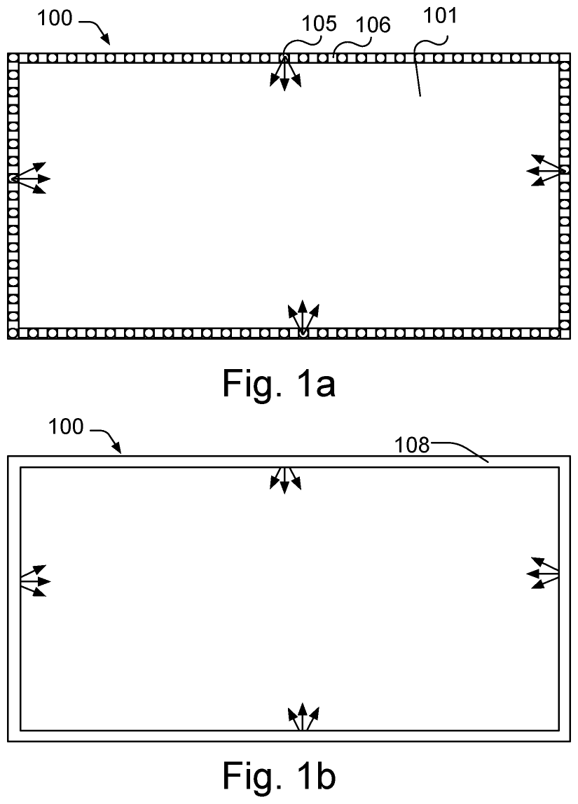

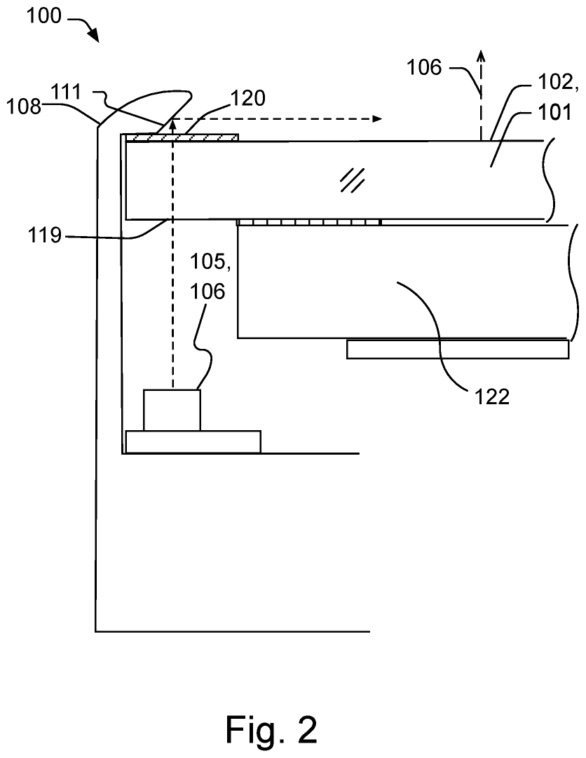

FIG. 1a is a top down view of a touch-sensing apparatus 100 comprising a panel 101 that defines a touch surface 102 extending in a plane having a normal axis 104. The touch-sensing apparatus 100 comprises a plurality of emitters 105 and detectors 106 arranged along a perimeter of the panel 101.

FIG. 1b is the same view as FIG. 1a but wherein component 108 is covering the emitters 105 and detectors 106.

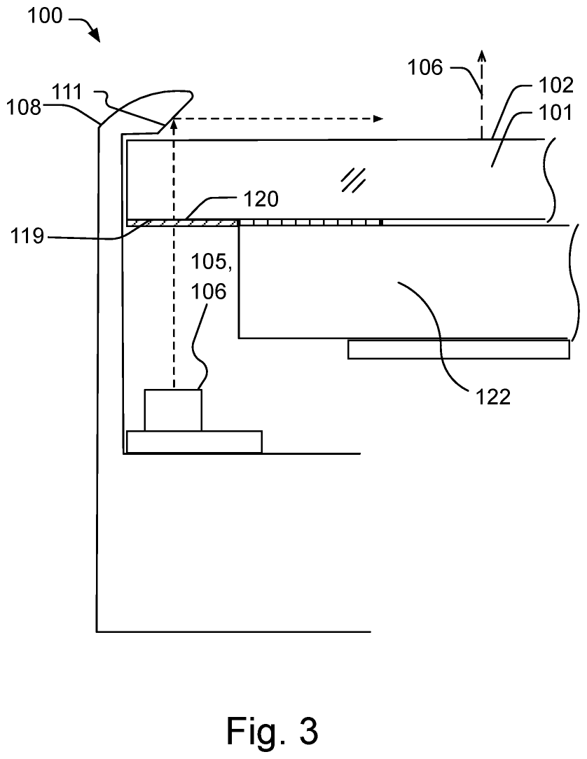

FIG. 2a is a schematic illustration of a touch-sensing apparatus 100 comprising a panel 101 that defines a touch surface 102 extending in a plane having a normal axis 104. The panel 101 is a light transmissive panel in one example. The touch-sensing apparatus 100 comprises a plurality of emitters 105 and detectors 106 arranged along a perimeter of the panel 101. FIG. 2a shows only an emitter 105 for clarity of presentation. The plurality of emitters 105 and detectors 106 are fixed to a first frame element 108 extending along the perimeter. The emitters 105 and detectors 106 thus have a substantially fixed position relative the first frame element 108. The emitters 105 and detectors 106 may be mounted to a PCT or substrate which is fixed to the first frame element 108. The substrate 117 may be fixed to the first frame element 108 by screws, pins, clasps, clips, clamps, adhesives, or any other fixation element. The substrate 117 may be arranged in a groove 118 of the first frame element 108, which may provide for a facilitated assembly and an interlocking effect of the substrate 117 into the first frame element 108. The substrate 117 may be mounted essentially in parallel with the plane in which the panel 101 extends. Arranging the substrate in parallel with the panel 101 provides for minimizing the width of the touch sensing apparatus 100 in a direction perpendicular to the plane, i.e. along the normal axis 104. A more compact touch sensing apparatus 100 may thus be provided. It should be understood however that the substrate 117 may be arranged with varying angles relative the panel 101 for also maximizing the amount of light reflected towards the touch surface 102.

The emitters 105 are arranged to emit light 112. The light directing surface 111 is arranged to receive the light from the emitter and direct the light across the touch surface 102 substantially parallel to the touch surface 102. Attenuation of the light e.g. by an object touching the touch surface 102 provides for the detection of the touch position as described above.

The light directing surface 111 may comprises a diffusive light scattering element surface. The diffusive light scattering surface effectively acts as a light source for diffusively emitted light.

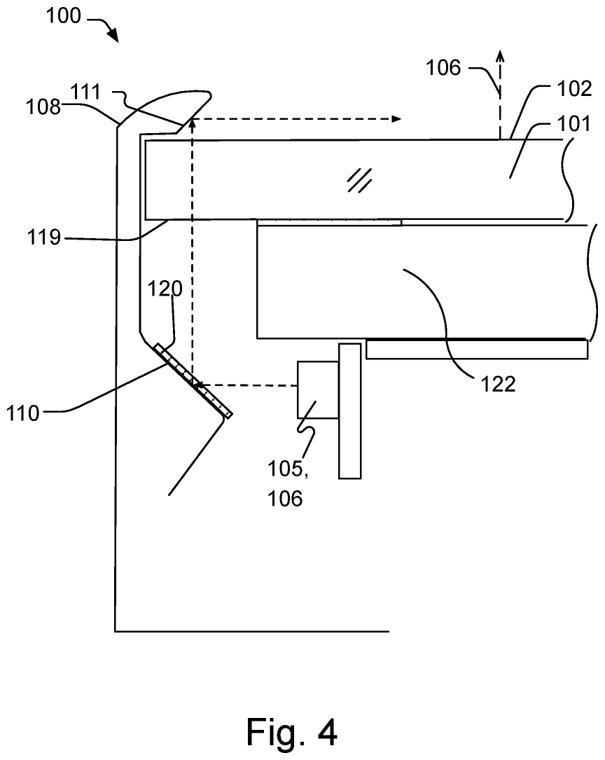

In FIG. 2, a visibility filter 120 is arranged on front surface 102 to hide (shield) the emitter 105 and detector 106 and the internal structure of the apparatus 100 from view through the front surface 102. The visibility filter 120 is non-transmissive (reflecting and/or absorbing) to visible light and transmissive to near infra-red (NIR) light, and preferably only transmissive to NIR light in the wavelength region of the propagating light. The visibility filter 120 may be implemented as a coating or film, in one or more layers. The visibility filter 120 can be implemented as a coating on the cover glass, e.g. a IR-transmissive print, paint or tape. It can also be implemented as a thin sheet that is held in contact with, or at some distance from, the cover glass. In FIG. 2, the visibility filter 120 extends from the edge of the panel 101 toward the center of the panel until it is substantially parallel or overlapping with the display component 106, although the visibility filter 120 may extend further towards the center of the panel. This ensures that space in which the emitters 105 and detectors 106 is substantially hidden from view (using visible light). In FIG. 3, the visibility filter 120 is arranged on the back surface of the panel 101. This enables the front surface 102 to be perfectly flat. This also prevents scratching or other damage to visibility filter 120 during manufacture or use.

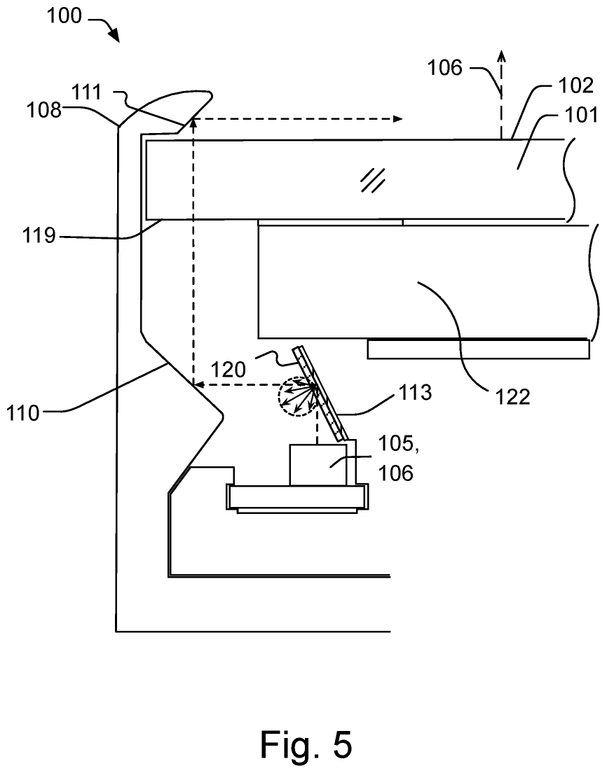

FIG. 4 shows a schematic representation of an emitter 105 mounted to a first frame element 108 with first and second light directing surfaces 110, 111. The first light directing surface 110 may comprises a diffusive light scattering surface. The diffusive light scattering surface effectively acts as a light source for diffusively emitted light. This provides for increasing the width of the scanlines across the touch surface 102 and improved detection of small objects. The distance between the diffusive light scattering surface and the light directing surfaces 111, may be maximized so that diffusively scattered light may spread over a wider angle and thereby increasing the width of the scanlines further. This provides for improved detection of small objects, particularly at the touch surface 102 closer to the edges of the panel 101.

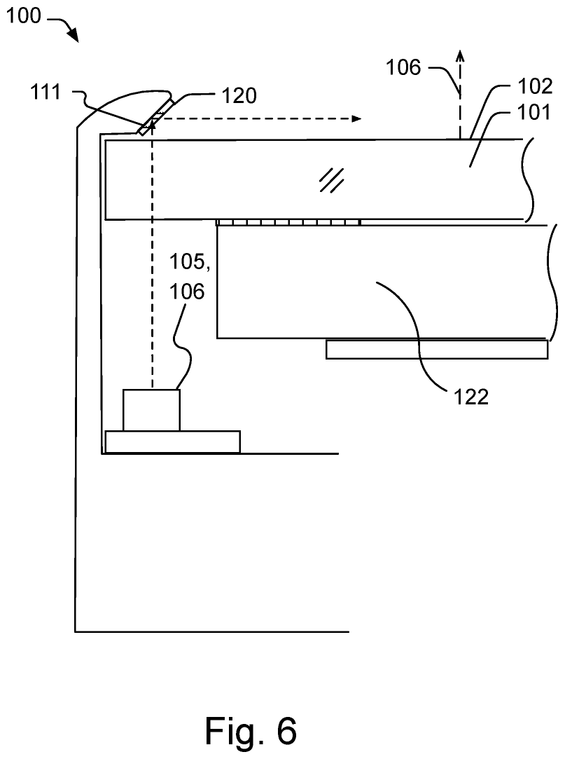

In FIG. 4, a visibility filter 120 is arranged on first light directing surface 110 to hide the potentially highly visible white surface of the diffusive light scattering surface from view, as well as the emitter 105 and detector 106. As shown in FIG. 5, the light may be reflected between the first and second light directing surfaces 110, 111, and a third light reflecting surface 113 on the first frame element 108. This may provide for a compact touch sensing apparatus 100 as the maximum dimension in a direction perpendicular to the normal 104 may be reduced when the path of the light is folded by an additional reflection at the third light reflecting surface 113. I.e. the emitters 105 and/or detectors 106 may be placed closer to the panel sides, and with a minimal interference with further display elements 122 arranged under the panel 101.

The third light directing surface 113 may comprises a diffusive light scattering element 113. The diffusive light scattering element 113 effectively acts as a light source for diffusively emitted light. This provides for increasing the width of the scanlines across the touch surface 102 and improved detection of small objects. The distance between the diffusive light scattering element 113 and the light directing surfaces 110, 111, may be maximized so that diffusively scattered light may spread over a wider angle and thereby increasing the width of the scanlines further. This provides for improved detection of small objects, particularly at the touch surface 102 closer to the edges of the panel 101. Different examples of diffusively scattering elements 113 are described further below.

The emitters 105 may thus be arranged to emit the light onto the third light reflecting surface 113. Any plurality of diffusively reflective surfaces 113 may be arranged along such light path to optimize the scanline width and the minimize light loss. The first light directing surface 110 and/or the second light directing surface 111 may comprise specularly reflective surfaces. Having a diffusive light scattering element 113 arranged in the path of the light provides for an optimized coverage of light in the plane 103 of the touch surface 102. The position and characteristics of the diffusive light scattering element 113 in relation to the emitters 105, detectors 106, and the panel 101 may be varied for optimization of the performance of the touch-sensing apparatus 100 to various applications. Further variations are conceivable within the scope of the present disclosure while providing for the advantageous benefits as generally described herein. The described examples refer primarily to aforementioned elements in relation to the emitters 105, to make the presentation clear, although it should be understood that the corresponding arrangements may also apply to the detectors 106. Different variations of the diffusive light scattering element 108 have been described further below.

In FIG. 5, a visibility filter 120 is arranged on the third light directing surface 113 to hide the potentially highly visible white surface of the diffusive light scattering surface 113 from view, as well as the emitter 105 and detector 106.

The panel 101 comprises a rear surface 119, opposite the touch surface 102, and panel sides extending between the touch surface 102 and the rear surface 119. The first and second light directing surfaces 110, 111, may be arranged within the panel sides, along a direction 104′ perpendicular to the normal axis 104, to receive light from the emitters 105, or to direct light to the detectors 106, through the panel 101.

The first and second light directing surfaces 110, 111, may be arranged outside the panel sides, along a direction 104′ perpendicular to the normal axis 104, to receive light from the emitters 105, or to direct light to the detectors 106, around the panel sides. Directing the light around the panel 101 provides for minimizing reflection losses and maximizing the amount of light available for the touch detection process.

It is conceivable however that in some examples the emitters 105 and/or the detectors 106 are arranged at least outside or at least partly outside the panel sides, in a direction 104′ perpendicular to the normal axis 104. The wavelength of the light may be preferably above 850 nm, such as 940 nm for increasing the reflection. The amount of light available for the touch detection may thus be increased.

The second light directing surface 111 may comprise a diffusive light scattering element.

As mentioned, the third light directing element 113 may comprise a diffusive light scattering element 113. Further examples of diffusive light scattering elements 113 will now be described.

The diffusive light scattering element 113 may be formed from a grooved surface, wherein the grooves generally run vertically or be substantially randomized. The groove density is preferably greater than 10 per mm in a horizontal plane. Optionally, the groove depth is up to 10 microns. Preferably, the average groove width is less than 2 microns. The grooves forming the diffusive light scattering element 113 can be formed by scratching or brushing of the surface. The diffusive light scattering element 113 may be formed from a surface of the first frame element 108 directly. Frame element 108 may be an extruded profile component or, alternatively, frame element 108 is made from brushed sheet metal. Preferably, frame element 108 is formed from anodized metal, such as anodized aluminum. The same may apply to the second frame element 109. Grooves for diffusively reflecting the light may be formed from scratching or brushing the anodized layer of the aluminum. In one embodiment, the anodization is a reflective type. In one example, the anodized metal, e.g. anodized aluminium, is cosmetically black in the visible spectral range, but diffusively light scattering in the near infrared range, e.g. wavelengths above 800 nm. It may be particularly advantageous to use wavelengths above 940 nm where many anodized materials start to reflect significantly (e.g. around 50%). A diffusive light scattering element 113 may be arranged at, or in, the surface receiving the emitted light from the emitters 105. It can also be implemented by distributing scattering particles (e.g. TiO₂) in the bulk of at least part of the frame element 108.

The diffusive light scattering element 113 may be configured as an essentially ideal diffuse reflector, also known as a Lambertian or near-Lambertian diffuser, which generates equal luminance in all directions in a hemisphere surrounding the diffusive light scattering element. Many inherently diffusing materials form a near-Lambertian diffuser. In an alternative, the diffusive light scattering element 108 may be a so-called engineered diffuser with well-defined light scattering properties. This provides for a controlled light management and tailoring of the light scattering abilities. A film with groove-like or other undulating structures may be dimensioned to optimize light scattering at particular angles. The diffusive light scattering element 113 may comprise a holographic diffuser. In a variant, the engineered diffuser is tailored to promote diffuse reflection into certain directions in the surrounding hemisphere, in particular to angles that provides for the desired propagation of light above and across the touch surface 102.

The diffusive light scattering element may be configured to exhibit at least 50% diffuse reflection, and preferably at least 90% diffuse reflection.

The diffusive light scattering element 113 may be implemented as a coating, layer or film applied by e.g. by anodization, painting, spraying, lamination, gluing, etc. In one example, the scattering element 113 is implemented as matte white paint or ink. In order to achieve a high diffuse reflectivity, it may be preferable for the paint/ink to contain pigments with high refractive index. One such pigment is TiO₂, which has a refractive index n=2.8. The diffusive light scattering element 113 may comprise a material of varying refractive index. It may also be desirable, e.g. to reduce Fresnel losses, for the refractive index of the paint filler and/or the paint vehicle to match the refractive index of the material on which surface it is applied. The properties of the paint may be further improved by use of EVOQUE™ Pre-Composite Polymer Technology provided by the Dow Chemical Company. There are many other coating materials for use as a diffuser that are commercially available, e.g. the fluoropolymer Spectralon, polyurethane enamel, barium-sulphate-based paints or solutions, granular PTFE, microporous polyester, GORE® Diffuse Reflector Product, Makrofol® polycarbonate films provided by the company Bayer AG, etc.

Alternatively, the diffusive light scattering element 113 may be implemented as a flat or sheet-like device, e.g. the above-mentioned engineered diffuser, diffuser film, or white paper which is attached by e.g. an adhesive. According to other alternatives, the diffusive light scattering element 113 may be implemented as a semi-randomized (non-periodic) micro-structure on an external surface possibly in combination with an overlying coating of reflective material.

A micro-structure may be provided on such external surface and/or an internal surface by etching, embossing, molding, abrasive blasting, scratching, brushing etc. The diffusive light scattering element 113 may comprise pockets of air along such internal surface that may be formed during a molding procedure. In another alternative, the diffusive light scattering element 113 may be light transmissive (e.g. a light transmissive diffusing material or a light transmissive engineered diffuser) and covered with a coating of reflective material at an exterior surface. Another example of a diffusive light scattering element 113 is a reflective coating provided on a rough surface.

The diffusive light scattering element 113 may comprise lenticular lenses or diffraction grating structures. Lenticular lens structures may be incorporated into a film. The diffusive light scattering element 113 may comprise various periodical structures, such as sinusoidal corrugations provided onto internal surfaces and/or external surfaces. The period length may be in the range of between 0.1 mm-1 mm. The periodical structure can be aligned to achieve scattering in the desired direction.

Hence, as described, the diffusive light scattering element 113 may comprise; white- or colored paint, white- or colored paper, Spectralon, a light transmissive diffusing material covered by a reflective material, diffusive polymer or metal, an engineered diffuser, a reflective semi-random micro-structure, in-molded air pockets or film of diffusive material, different engineered films including e.g. lenticular lenses, or other micro lens structures or grating structures. The diffusive light scattering element 113 preferably has low NIR absorption.

In a variation of any of the above embodiments wherein the diffusive light scattering element provides a reflector surface, the diffusive light scattering element may be provided with no or insignificant specular component. This may be achieved by using either a matte diffuser film in air, an internal reflective bulk diffusor or a bulk transmissive diffusor. This allows effective scanline broadening by avoiding the narrow, super-imposed specular scanline usually resulting from a diffusor interface having a specular component, and providing only a broad, diffused scanline profile. By removing the super-imposed specular scanline from the touch signal, the system can more easily use the broad, diffused scanline profile. Preferably, the diffusive light scattering element has a specular component of less than 1%, and even more preferably, less than 0.1%. Alternatively, where the specular component is greater than 0.1%, the diffusive light scattering element is preferably configured with surface roughness to reduce glossiness. E.g. micro structured.

The touch sensing apparatus may further comprise a shielding layer (not shown). The shielding layer may define an opaque frame around the perimeter of the panel 101. The shielding layer may increase the efficiency in providing the diffusively reflected light in the desired direction, e.g. by recycling the portion of the light that is diffusively reflected by the diffusive light scattering element 113 in a direction away from the panel 101.

The panel 101 may be made of glass, poly(methyl methacrylate) (PMMA) or polycarbonates (PC). The panel 101 may be designed to be overlaid on or integrated into a display device or monitor (not shown). It is conceivable that the panel 101 does not need to be light transmissive, i.e. in case the output of the touch does not need to be presented through panel 101, via the mentioned display device, but instead displayed on another external display or communicated to any other device, processor, memory etc.

In FIG. 6, a visibility filter 120 is arranged on the second light directing surface 111 to reduce the visual impact of the potentially highly visible white surface of the diffusive light scattering surface of surface 11.

The position of visibility filter 120 shown in FIGS. 2 to 6 can be combined in any configuration to further enhance aesthetic appearance of the apparatus and minimize visibility of components and surfaces below the panel 120.

As used herein, the emitters 105 may be any type of device capable of emitting radiation in a desired wavelength range, for example a diode laser, a VCSEL (vertical-cavity surface-emitting laser), an LED (light-emitting diode), an incandescent lamp, a halogen lamp, etc. The emitter 105 may also be formed by the end of an optical fiber. The emitters 105 may generate light in any wavelength range. The following examples presume that the light is generated in the infrared (IR), i.e. at wavelengths above about 750 nm. Analogously, the detectors 106 may be any device capable of converting light (in the same wavelength range) into an electrical signal, such as a photo-detector, a CCD device, a CMOS device, etc.

With respect to the discussion above, “diffuse reflection” refers to reflection of light from a surface such that an incident ray is reflected at many angles rather than at just one angle as in “specular reflection”. Thus, a diffusively reflecting element will, when illuminated, emit light by reflection over a large solid angle at each location on the element. The diffuse reflection is also known as “scattering”.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the specific arrangement of emitters and detectors as illustrated and discussed in the foregoing is merely given as an example. The inventive coupling structure is useful in any touch-sensing system that operates by transmitting light, generated by a number of emitters, across a panel and detecting, at a number of detectors, a change in the received light caused by an interaction with the transmitted light at the point of touch.

1.-7. (canceled)

8. A touch sensing apparatus comprising
a panel that defines a touch surface extending in a plane having a normal axis and a back surface opposite the touch surface,
a display arranged proximal to the back surface and configured to display an image through a display portion of the touch surface, and
a plurality of emitters and detectors arranged along a perimeter of the panel and beneath the panel,
wherein the emitters are arranged to emit non-visible light and the at least one light directing surfaces is arranged to receive the light and direct the light across the touch surface substantially parallel to the touch surface, and
wherein the apparatus comprising at least one optical filter arranged outside of the display portion of the touch surface and configured to filter visible light.

9. A touch sensing apparatus according to claim 8, wherein an optical filter is positioned on a touch surface of the panel.

10. A touch sensing apparatus according to claim 8, wherein an optical filter is positioned on a back surface of the panel.

11. A touch sensing apparatus according to claim 8, wherein the at least one light directing surface of the touch sensing apparatus comprises a first light directing surface proximal to the back surface.

12. A touch sensing apparatus according to claim 11, wherein an optical filter is positioned on the first light directing surface.

13. A touch sensing apparatus according to claim 8, wherein the at least one light directing surface of comprises a second light directing surface proximal to the touch surface.

14. A touch sensing apparatus according to claim 13, wherein an optical filter is positioned on the second light directing surface.

15. A touch sensing apparatus according to claim 11, wherein the at least one light directing surface of the touch sensing apparatus further comprises a third light directing surface proximal to the back surface.

16. A touch sensing apparatus according to claim 15, wherein an optical filter is positioned on the third light directing surface.

17. A touch sensing apparatus according to claim 8, wherein the touch sensing apparatus comprises a frame element and frame element comprises the at least one light directing surface.

18. A touch sensing apparatus according to claim 17, wherein the frame element is extruded or made from brushed metal.

19. A touch sensing apparatus according to claim 8, wherein the at least one light directing surface comprises a diffusive light scattering element.

20. A touch sensing apparatus according claim 19, wherein the diffusive light scattering element is anodized aluminum surface.

21. A touch sensing apparatus according to claim 19, wherein the diffusive light scattering element is configured to scatter light above wavelengths of 800 nm.

22. A touch sensing apparatus according to claim 8, wherein the a plurality of emitters and detectors are mounted on a substrate and the substrate is mounted in a plane parallel with the panel or in a plane perpendicular with the panel.

23. A touch sensing apparatus according to claim 8, wherein the optical filter extends from an edge of the panel toward the center of the panel until it is substantially parallel or overlapping with the display.

24. A touch sensing apparatus according to claim 8, wherein the optical filter is configured to hide the plurality of emitters and detectors from view in the visible spectrum.

25. A touch sensing apparatus according to claim 8, wherein the optical filter is configured to be non-transmissive to visible light and transmissive to near infra-red light.
